(19) United States
(12) Patent Application Publication
(10) Pub. No.: US 2016/0358037 A1
(43) Pub. Date: Dec. 8, 2016

(54) SYSTEMS AND METHODS FOR DETERMINING FEATURE HEIGHT FROM LAMINOGRAPHIC IMAGES

(71) Applicant: Morpho Detection, LLC, Newark, CA (US)

(72) Inventors: Forrest Frank Hopkins, San Antonio, TX (US); Clifford Bueno, Clifton Park, NY (US); Walter I. Garms, Berkeley, CA (US)

(21) Appl. No.: 14/731,912

(22) Filed: Jun. 5, 2015

(51) Int. Cl. G06K 9/52; G06T 7/00; G06K 9/46; G01N 23/04; G06T 7/60

(52) U.S. Cl. CPC G06K 9/52; G01N 23/046; G06T 7/60; G06K 9/4604; G06T 7/0085; G06T 7/0012; G06T 2207/30204; G06T 2207/10081

(57) ABSTRACT

A method for determining a height of a feature of an object is provided. The method includes generating, using a computing device, on an image of a scan volume that includes the object, a marker that crosses an edge of the feature, calculating, using the computing device, for each of a plurality of laminographic images, a profile along the generated marker, each laminographic image having an associated height, computing, using the computing device, an edge slope associated with the feature for each of the plurality of profiles, identifying, using the computing device, a focused laminographic image as the laminographic image of the plurality of laminographic images having the steepest edge slope, and determining the height of the object as the height associated with the focused laminographic image.

### STATEMENT REGARDING FEDERALLY SPONSORED RESEARCH AND DEVELOPMENT

This invention was made with Government support under contract number HSHQDC-07-C-00036 awarded by the Department of Homeland Security, Domestic Nuclear Deterrence Office. The Government has certain rights in this invention.

### BACKGROUND

The embodiments described herein relate generally to laminographic images, and more particularly, to determining a height of a feature in a scan volume using a plurality of laminographic images.

In some computed tomography (CT) imaging system configurations, an x-ray source projects a fan-shaped beam which is collimated to lie within an X-Y plane of a Cartesian coordinate system and generally referred to as an “imaging plane”. The x-ray beam passes through an object being imaged. The beam, after being attenuated by the object, impinges upon an array of radiation detectors. The intensity of the attenuated radiation beam received at the detector array is dependent upon the attenuation of the x-ray beam by the object. Each detector element of the array produces a separate electrical signal that is a measurement of the beam intensity at each detector location. The intensity measurements from all the detectors are acquired separately to produce a transmission profile and reconstruct an image of the object.

In some known systems, it may be difficult to identify relatively small, thin components in a CT image. For example, although wires may be easily observable in projection images, they may not be easily discernible in a CT image because they are not often aligned with the imaging planes, and thus may appear as isolated points. Further, at least some known CT systems generate one or more two-dimensional projection images that provide an overview of a scanned volume. However, these two-dimensional projection images do not provide a height of individual features within the volume.

### BRIEF SUMMARY

In one aspect, a method for determining a height of a feature of an object is provided. The method includes generating, using a computing device, on an image of a scan volume that includes the object, a marker that crosses an edge of the feature, calculating, using the computing device, for each of a plurality of laminographic images, a profile along the generated marker, each laminographic image having an associated height, computing, using the computing device, an edge slope associated with the feature for each of the plurality of profiles, identifying, using the computing device, a focused laminographic image as the laminographic image of the plurality of laminographic images having the steepest edge slope, and determining the height of the object as the height associated with the focused laminographic image.

In another aspect, a processing device for determining a height of a feature of an object is provided. The processing device is configured to cause a computer to implement a method including generating, on an image of a scan volume that includes the object, a marker that crosses an edge of the feature, calculating, for each of a plurality of laminographic images, a profile along the generated marker, each laminographic image having an associated height, computing an edge slope associated with the feature for each of the plurality of profiles, identifying a focused laminographic image as the laminographic image of the plurality of laminographic images having the steepest edge slope, and determining the height of the object as the height associated with the focused laminographic image.

In yet another aspect, a system for determining a height of a feature of an object is provided. The system includes an imaging device, and a computing device communicatively coupled to the imaging device, the computing device configured to generate, on an image of a scan volume that includes the object, a marker that crosses an edge of the feature, calculate, for each of a plurality of laminographic images, a profile along the generated marker, each laminographic image having an associated height, compute an edge slope associated with the feature for each of the plurality of profiles, identify a focused laminographic image as the laminographic image of the plurality of laminographic images having the steepest edge slope, and determine the height of the object as the height associated with the focused laminographic image.

### BRIEF DESCRIPTION OF THE DRAWINGS

FIG. 1 is a perspective view of an exemplary CT imaging system.

FIG. 2 is a schematic diagram of the CT imaging system shown in FIG. 1.

FIG. 3 is a schematic diagram of a portion of the CT imaging system shown in FIG. 2.

FIG. 4 is a block diagram of an exemplary computing device that may be used with the CT imaging system shown in FIGS. 1-3.

FIG. 5 is an image of an object.

FIG. 6A is a portion of the image shown in FIG. 5.

FIG. 6B is an x-ray attenuation profile generated for the image shown in FIG. 5

FIG. 7 shows a plurality of laminographic images and associated x-ray attenuation profiles.

FIG. 8 is an image indicating a height of a feature in the object shown in FIG. 5.

### DETAILED DESCRIPTION

Using the systems and methods described herein, a height of a feature of an object is determined by analyzing a plurality of laminographic images acquired at various heights. An x-ray attenuation profile across an edge of the feature is calculated for each laminographic image. The laminographic image with a profile having the steepest edge slope represents the height of the object. Accordingly, using the systems and methods described herein, three-dimensional information can be rapidly extracted from projection data sets that are produced by imaging systems.

As used herein, a “height” refers to a distance from a predetermined imaging plane along a line orthogonal to the imaging plane. In the exemplary embodiments described herein, the height is determined in a direction orthogonal to a horizontal (i.e., x-z plane). However, those of skill in the art will appreciate that the predetermined imaging plane from which the height is determined may have any orientation and/or or position within a three-dimensional coordinate system.

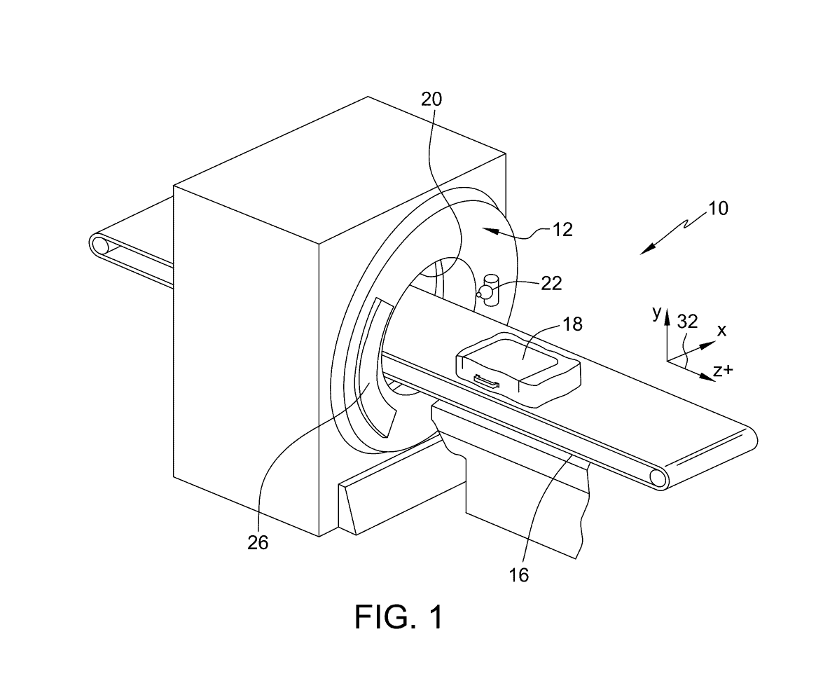

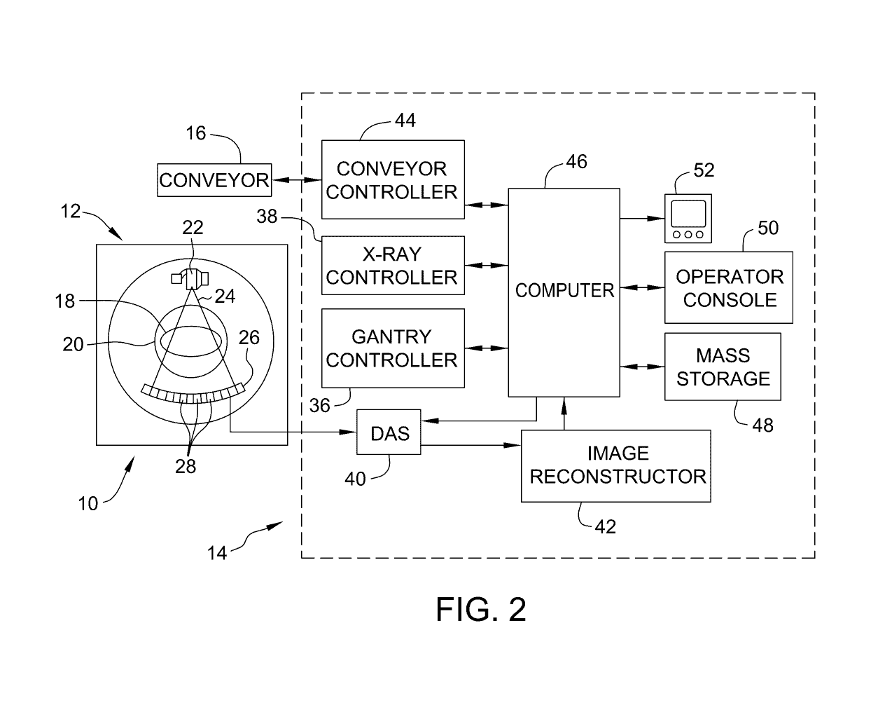

Referring now to FIGS. 1 and 2, a computed tomography (CT) imaging system 10 is shown. CT imaging system 10 is shown having a gantry 12, which is representative of a CT scanner, a control system 14, and a motorized conveyor belt 16 for positioning an object 18, such as a piece of luggage, in a gantry opening 20 defined through gantry 12. Gantry 12 includes an x-ray source 22 that projects a fan beam of x-rays 24 toward a detector array 26 on the opposite side of gantry 12. Detector array 26 is formed by detector elements 28, which are radiation detectors that each produce a signal having a magnitude that represents and is dependent on the intensity of the attenuated x-ray beam after it has passed through object 18 being imaged. During a helical scan that acquires x-ray projection data, gantry 12 along with the x-ray source 22 and detector array 26 rotate within an x-y plane and around object 18 about a center of rotation, while object 18 is moved through gantry 12 in a z-direction 32 perpendicular to the x-y plane of rotation. In the exemplary embodiment, detector array 26 includes a plurality of detector rings each having a plurality of detector elements 28, the detector rings having an angular configuration corresponding to x-ray source 22. Although the exemplary embodiment discuss a CT imaging system, those of skill in the art will appreciate that the systems and method described herein may be implemented in other types of imaging systems (e.g., radiographic systems and/or laminographic systems that include flat panels, a single linear arrays, or multi-tier linear arrays as detectors).

Gantry 12 and x-ray source 22 are controlled by control system 14, which includes a gantry controller 36, an x-ray controller 38, a data acquisition system (DAS) 40, an image reconstructor 42, a conveyor controller 44, a computer 46, a mass storage-system 48, an operator console 50, and a display device 52. Gantry controller 36 controls the rotational speed and position of gantry 12, while x-ray controller 38 provides power and timing signals to x-ray source 22, and data acquisition system 40 acquires analog data from detector elements 28 and converts the data to digital form for subsequent processing. Image reconstructor 42 receives the digitized x-ray data from data acquisition system 40 and performs an image reconstruction process that involves filtering the projection data using a helical reconstruction algorithm.

Computer 46 is in communication with the gantry controller 36, x-ray controller 38, and conveyor controller 44 whereby control signals are sent from computer 46 to controllers 36, 38, 44 and information is received from controllers 36, 38, 44 by computer 46. Computer 46 also provides commands and operational parameters to data acquisition system 40 and receives reconstructed image data from image reconstructor 42. The reconstructed image data is stored by computer 46 in mass storage system 48 for subsequent retrieval. An operator interfaces with computer 46 through operator console 50, which may include, for example, a keyboard and a graphical pointing device, and receives output, such as, for example, a reconstructed image, control settings and other information, on display device 52.

Communication between the various system elements of FIG. 2 is depicted by arrowhead lines, which illustrate a means for either signal communication or mechanical operation, depending on the system element involved. Communication amongst and between the various system elements may be obtained through a hardwired or a wireless arrangement. Computer 46 may be a standalone computer or a network computer and may include instructions in a variety of computer languages for use on a variety of computer platforms and under a variety of operating systems. Other examples of computer 46 include a system having a microprocessor, microcontroller or other equivalent processing device capable of executing commands of computer readable data or program for executing a control algorithm. In order to perform the prescribed functions and desired processing, as well as the computations therefore (e.g., the execution of filtered back projection, fourier analysis algorithm(s), the control processes prescribed herein, and the like), computer 46 may include, but not be limited to, a processor(s), memory, storage, register(s), timing, interrupt(s), communication interfaces, and input/output signal interfaces, as well as combinations including at least one of the foregoing. For example, computer 46 may include input signal filtering to enable accurate sampling and conversion or acquisitions of such signals from communications interfaces. As described above, exemplary embodiments can be implemented through computer-implemented processes and apparatuses for practicing those processes.

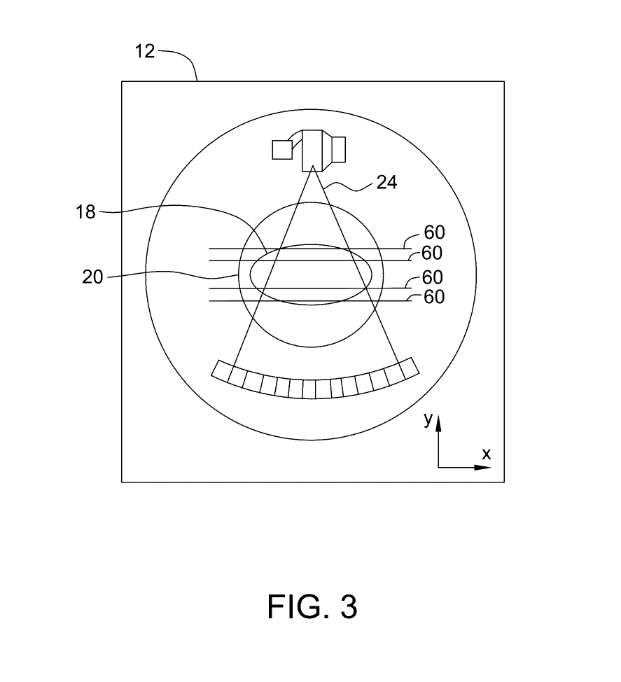

As shown in FIG. 3, CT imaging system 10 may be used to generate a set of laminographic images 60 for object 18. As used herein, a set of laminographic images 60 refers to a plurality of two-dimensional images acquired in parallel planes. For example, laminographic images 60 shown in FIG. 3 are two-dimensional images acquired at parallel x-z planes located at different heights above conveyor belt 16. Notably, laminographic images 60 may be located at parallel planes having any orientation. For example, laminographic images 60 may be acquired at parallel x-y planes or parallel y-z planes. Further, although four laminographic images 60 are shown in FIG. 3, those of skill in the art will appreciate that any number of laminographic images 60 may be acquired.

CT imaging system 10 acquires laminographic images 60 using any suitable method. For example, U.S. patent application Ser. No. 14/514,585, filed Oct. 15, 2014, which is incorporated by reference herein in its entirety, describes systems methods for acquiring laminographic images. Further, devices other than a CT imaging system, such as a laminographic imaging system, may be used to acquire laminographic images 60.

The systems and methods describes herein enable determining a height (e.g., above conveyor belt 16) of a feature included in object 18 from a set of laminographic images 60. As used herein, a “height” refers to a distance of the object feature from a reference plane (e.g., a plane formed by an upper surface of conveyor belt 16). The object feature may be an item included within object 18 (e.g., an article included within a suitcase) or an aspect of object 18 (e.g., an edge, corner, or other structural feature of object 18).

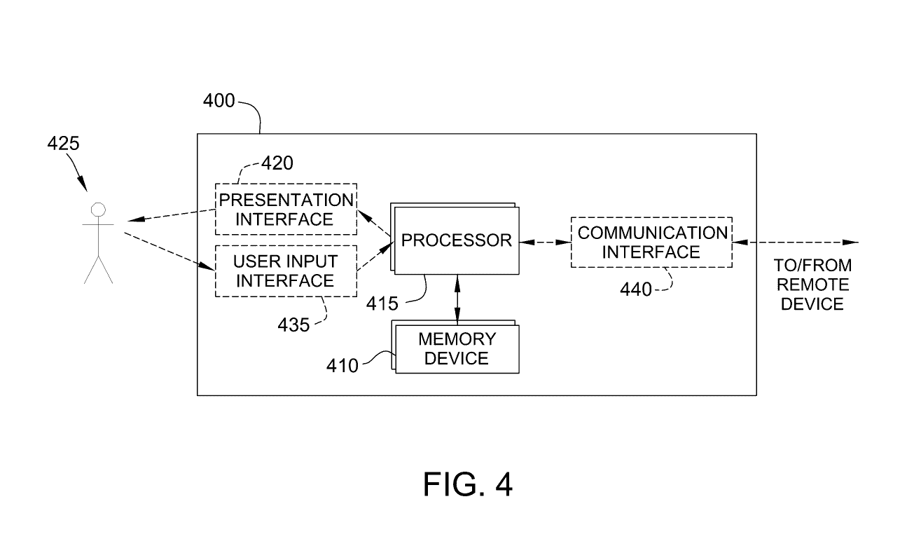

FIG. 4 is a block diagram of a computing device 400 that may be used to determine a height of an object feature, as described herein. Computing device 400 may be implemented as part of control system 14 or may be a separate computing device in communication with CT imaging system 10 or another imaging system. Computing device 400 includes at least one memory device 410 and a processor 415 that is coupled to memory device 410 for executing instructions. In some implementations, executable instructions are stored in memory device 410. The set of laminographic images 60 may also be stored in memory device 410. In the exemplary implementation, computing device 400 performs one or more operations described herein by programming processor 415. For example, processor 415 may be programmed by encoding an operation as one or more executable instructions and by providing the executable instructions in memory device 410.

Processor 415 may include one or more processing units (e.g., in a multi-core configuration). Further, processor 415 may be implemented using one or more heterogeneous processor systems in which a main processor is present with secondary processors on a single chip. In another illustrative example, processor 415 may be a symmetric multi-processor system containing multiple processors of the same type. Further, processor 415 may be implemented using any suitable programmable circuit including one or more systems and microcontrollers, microprocessors, reduced instruction set circuits (RISC), application specific integrated circuits (ASIC), programmable logic circuits, field programmable gate arrays (FPGA), graphics processing units (GPU), and any other circuit capable of executing the functions described herein.

In the exemplary implementation, memory device 410 is one or more devices that enable information such as executable instructions and/or other data to be stored and retrieved. Memory device 410 may include one or more computer readable media, such as, without limitation, dynamic random access memory (DRAM), static random access memory (SRAM), a solid state disk, and/or a hard disk. Memory device 410 may be configured to store, without limitation, application source code, application object code, source code portions of interest, object code portions of interest, configuration data, execution events and/or any other type of data. Further, reference templates may be stored on memory device 410.

In the exemplary implementation, computing device 400 includes a presentation interface 420 that is coupled to processor 415. Presentation interface 420 presents information to a user 425. For example, presentation interface 420 may include a display adapter (not shown) that may be coupled to a display device, such as a cathode ray tube (CRT), a liquid crystal display (LCD), an organic LED (OLED) display, and/or an “electronic ink” display. In some implementations, presentation interface 420 includes one or more display devices.

In the exemplary implementation, computing device 400 includes a user input interface 435. User input interface 435 is coupled to processor 415 and receives input from user 425. User input interface 435 may include, for example, a keyboard, a pointing device, a mouse, a stylus, a touch sensitive panel (e.g., a touch pad or a touch screen), a gyroscope, an accelerometer, a position detector, and/or an audio user input interface. A single component, such as a touch screen, may function as both a display device of presentation interface 420 and user input interface 435.

Computing device 400, in the exemplary implementation, includes a communication interface 440 coupled to processor 415. Communication interface 440 communicates with one or more remote devices (e.g., in some embodiments, CT imaging system 10). To communicate with remote devices, communication interface 440 may include, for example, a wired network adapter, a wireless network adapter, and/or a mobile telecommunications adapter.

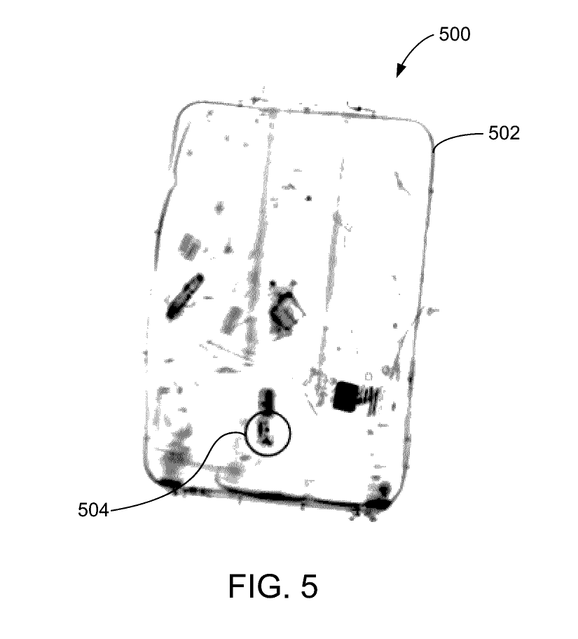

FIG. 5 is an image 500 of an object 502, such as object 18 (shown in FIGS. 1-3). In FIG. 5, image 500 is itself a laminographic image. Alternatively, image 500 be any type of image (e.g., an orthographic or projection image) that enables computing device 400 to function as described herein. As shown in FIG. 5, object 502 includes a feature 504. In this embodiment, feature 504 is an item included within object 502. Alternatively, as explained above, feature 504 may be an aspect of object 502. Image 500 may be produced, for example, by projecting through a CT volume, or by creating an orthographic projection from CT data as described, for example, in U.S. Pat. No. 7,515,675, which is incorporated by reference herein in its entirety.

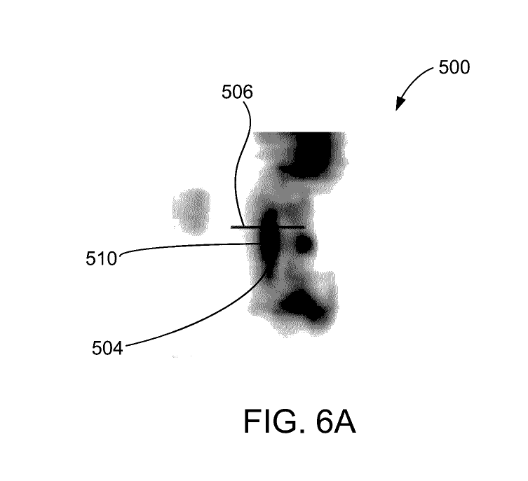

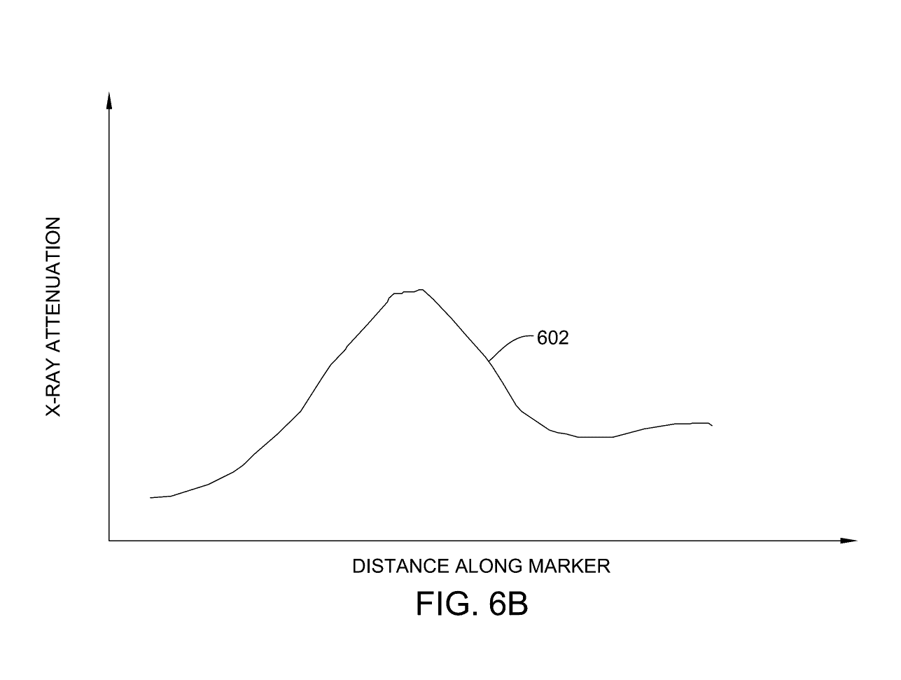

To determine a height of feature 504, as shown in FIG. 6A, a marker 506 is generated on image 500. In the exemplary embodiment, marker 506 is a line that crosses at least one edge 510 of feature 504. Alternatively, marker 506 may be any shape (e.g., a curve, a sequence of line segments, etc.) that facilitates determining a height of feature 504.

Marker 506 may be generated by user 425 operating computing device 400. For example, image 500 may be displayed on presentation interface 420, and user 425 may generate marker 506 on the displayed image 500 using user input interface 435. Alternatively, marker 506 may be automatically generated by computing device 400. For example, computing device 400 may use an automatic target recognition algorithm to identify one or more features 504 of interest and generate markers 506 for those features 504. In another embodiment, user 425 may select feature 504, and computing device 400 automatically generates marker 506 based on the user selection.

Once marker 506 is generated, for each of a plurality of laminographic images, computing device 400 calculates a profile of feature 504 along marker 506. In the exemplary embodiment, each profile is an x-ray attenuation profile of feature 504 taken along marker 506. For example, FIG. 6B shows a sample profile 602 taken along marker 506. As shown in FIG. 6B, the x-ray attenuation is higher for darker areas in image 500 and lower for brighter areas in image 500.

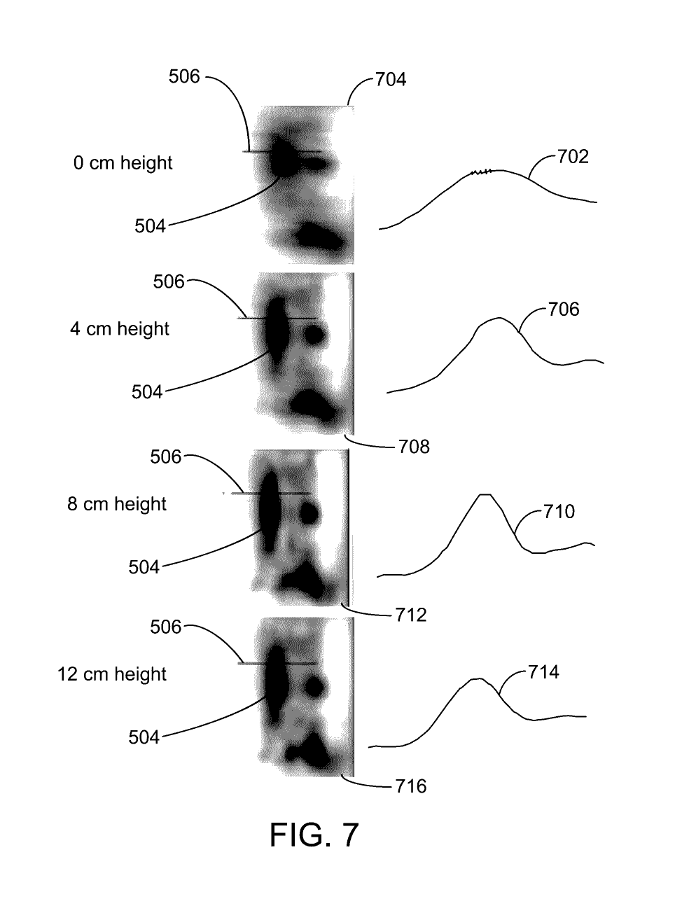

As described above, a profile is calculated for each of the plurality of laminographic images. FIG. 7 shows a plurality of laminographic images each acquired at a different height, and the corresponding profile calculated for each laminographic image. Specifically, a first profile 702 corresponds to a first laminographic image 704 acquired at a height of 0 centimeters (cm), a second profile 706 corresponds to a second laminographic image 708 acquired at a height of 4 cm, a third profile 710 corresponds to a third laminographic image 712 acquired at a height of 8 cm, and a fourth profile 714 corresponds to a fourth laminographic image 716 acquired at a height of 12 cm. In the exemplary embodiment, the respective heights are determined relative to the plane of first laminographic image 704, which is the plane of the upper surface of belt 16. Alternatively, the respective heights may be determined relative to any parallel plane. For illustration, marker 506 is shown in first, second, third, and fourth laminographic images 704, 708, 712, and 716.

For each profile, an associated edge slope is calculated. In the exemplary embodiment, the edge slope is the maximum slope (regardless of sign) of the particular profile. The maximum slope may be determined, for example, by taking the derivative of the profile, and determining the largest value (regardless of sign). Alternatively, the edge slope is any slope indicative of the sharpness (relative to the feature) of the associated laminographic image. Other imaging processes may also be performed on the laminographic images (e.g., applying edge detection filters).

The laminographic image having the steepest edge slope relative to the remaining laminographic images is determined to be a focused laminographic image. Specifically, steeper edge slopes correspond to more rapid changes in x-ray attenuation, which in turn correspond to sharper laminographic images. The height associated with the focused laminographic image is then determined to be the height of the feature.

To determine the laminographic image having the steepest edge slope, computing device 400 may compare all of the calculated edge slopes to one another. Alternatively, computing device 400 may determine the laminographic image having the steepest edge slope using any suitable method. For example, in one embodiment, computing device 400 performs coarse focusing followed by fine focusing. For example, computing device 400 may initially only analyze the edge slope of a subset of laminographic images (e.g., every tenth laminographic image). Once computing device 400 determines which laminographic image in the subset has the steepest edge slope, other laminographic images proximate that laminographic image are analyzed.

Referring to FIG. 7, the maximum slope of third profile 710 is steeper than the maximum slopes of first, second, and fourth profiles 702, 706, and 714. Accordingly, third laminographic image 712 is the focused laminographic image, and the height of feature 504 is set as the height of third laminographic image 712 (i.e., 8 cm).

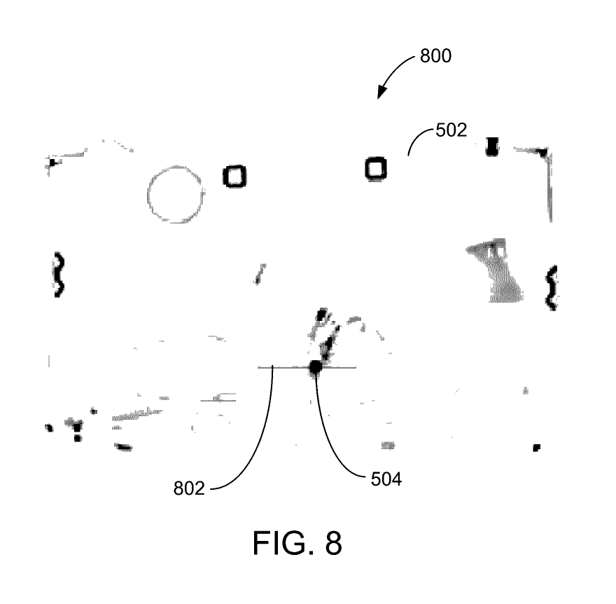

The determined height of feature 504 may be used in a number of ways. In one embodiment, the height is reported to user 425 (e.g., via presentation interface 420). In another embodiment, the focused laminographic image is displayed (e.g., via presentation interface 420). In yet another embodiment, an orthographic image indicating the height of feature 504 is displayed (e.g., on presentation interface 420). For example, FIG. 8 shows an orthographic image 800 of object 502. The height of feature 504 is indicated in image 800 by a height indicator 802. Although height indicator 802 is shown as a line in FIG. 8, those of skill in the art will appreciate that height indicator 802 may take any suitable form.

The systems and methods described herein facilitate determining a height of a feature of an object in an image. Knowledge of the height of one or more features can provide greater conceptual awareness for a screener by providing a relationship between features, such as wires, and other features, such as potential explosives. The embodiments described herein analyze a plurality of laminographic images acquired at various heights. An x-ray attenuation profile across an edge of the feature is calculated for each laminographic image. The laminographic image with a profile having the steepest edge slope represents the height of the object. Accordingly, using the systems and methods described herein, three-dimensional information can be rapidly extracted from projection data sets that are produced by imaging systems.

The systems and methods described herein may be used to detect contraband. As used herein, the term “contraband” refers to illegal substances, explosives, narcotics, weapons, special nuclear materials, dirty bombs, nuclear threat materials, a threat object, and/or any other material that a person is not allowed to possess in a restricted area, such as an airport. Contraband may be hidden within a subject (e.g., in a body cavity of a subject) and/or on a subject (e.g., under the clothing of a subject). Contraband may also include objects that can be carried in exempt or licensed quantities intended to be used outside of safe operational practices, such as the construction of dispersive radiation devices.

A computer, such as those described herein, includes at least one processor or processing unit and a system memory. The computer typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Exemplary embodiments of methods and systems are described above in detail. The methods and systems are not limited to the specific embodiments described herein, but rather, components of systems and/or steps of the methods may be used independently and separately from other components and/or steps described herein. Accordingly, the exemplary embodiment can be implemented and used in connection with many other applications not specifically described herein.

Technical effects of the systems and methods described herein include at least one of (a) generating, on an image of a scan volume that includes an object, a marker that crosses an edge of a feature; (b) calculating, for each of a plurality of laminographic images, a profile along the generated marker, each laminographic image having an associated height; (c) computing, using the computing device, an edge slope associated with the feature for each of the plurality of profiles; (d) identifying, using the computing device, a focused laminographic image as the laminographic image of the plurality of laminographic images having the steepest edge slope; and (e) determining the height of the object as the height associated with the focused laminographic image.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for determining a height of a feature of an object, said method comprising:
generating, using a computing device, on an image of a scan volume that includes the object, a marker that crosses an edge of the feature;
calculating, using the computing device, for each of a plurality of laminographic images, a profile along the generated marker, each laminographic image having an associated height;
computing, using the computing device, an edge slope associated with the feature for each of the plurality of profiles;
identifying, using the computing device, a focused laminographic image as the laminographic image of the plurality of laminographic images having the steepest edge slope; and
determining the height of the object as the height associated with the focused laminographic image.

2. A method in accordance with claim 1, wherein generating a marker comprises generating a marker based on a user input identifying the marker.

3. A method in accordance with claim 1, wherein generating a marker comprises automatically generating the marker using the computing device.

4. A method in accordance with claim 1, further comprising generating the plurality of laminographic images using an imaging system.

5. A method in accordance with claim 1, wherein the edge slope of each profile is a maximum slope associated with the profile.

6. A method in accordance with claim 1, further comprising displaying the focused laminographic image.

7. A method in accordance with claim 1, wherein each profile is an x-ray attenuation profile.

8. A processing device for determining a height of a feature of an object, said processing device configured to cause a computer to implement a method including:
generating, on an image of a scan volume that includes the object, a marker that crosses an edge of the feature;
calculating, for each of a plurality of laminographic images, a profile along the generated marker, each laminographic image having an associated height;
computing an edge slope associated with the feature for each of the plurality of profiles;
identifying a focused laminographic image as the laminographic image of the plurality of laminographic images having the steepest edge slope; and
determining the height of the object as the height associated with the focused laminographic image.

9. A processing device in accordance with claim 8, wherein generating a marker comprises generating a marker based on a user input identifying the marker.

10. A processing device in accordance with claim 8, wherein generating a marker comprises automatically generating the marker.

11. A processing device in accordance with claim 8, wherein the edge slope of each profile is a maximum slope associated with the profile.

12. A processing device in accordance with claim 8, wherein said processing device is further configured to cause the computer to display the focused laminographic image.

13. A processing device in accordance with claim 8, wherein each profile is an x-ray attenuation profile.

14. A system for determining a height of a feature of an object, the system comprising:
an imaging device; and
a computing device communicatively coupled to said imaging device, said computing device configured to:
generate, on an image of a scan volume that includes the object, a marker that crosses an edge of the feature;
calculate, for each of a plurality of laminographic images, a profile along the generated marker, each laminographic image having an associated height;
compute an edge slope associated with the feature for each of the plurality of profiles;
identify a focused laminographic image as the laminographic image of the plurality of laminographic images having the steepest edge slope; and
determine the height of the object as the height associated with the focused laminographic image.

15. A system in accordance with claim 14, wherein to generate a marker, said computing device is configured to generate a marker based on a user input identifying the marker.

16. A system in accordance with claim 14, wherein to generate a marker, said computing device is configured to automatically generate the marker.

17. A system in accordance with claim 14, wherein the edge slope of each profile is a maximum slope associated with the profile.

18. A system in accordance with claim 14, wherein said computing device is further configured to display the focused laminographic image.

19. A system in accordance with claim 14, wherein each profile is an x-ray attenuation profile.

20. A system in accordance with claim 14, wherein said imaging device is a computed tomography imaging system configured to acquire the plurality of laminographic images.
